(19) United States
(12) Patent Application Publication
(10) Pub. No.: US 2002/0184101 A1
(43) Pub. Date: Dec. 5, 2002

(54) Method and apparatus for integrating with multiple application systems

(76) Inventors: Rajiv Raghavendrarao Gidadhubli, Centreville, VA (US); Richard Carr, Fairfax, VA (US); Sunil Arjandas Melwani, Fairfax, VA (US); Narasimha Gururaja Rao, Centreville, VA (US)

Correspondence Address: STAAS & HALSEY LLP, 700 11TH STREET, NW, SUITE 500, WASHINGTON, DC, 20001, US

(21) Appl. No.: 09/750,295

(22) Filed: Mar. 2, 2001

(51) Int. Cl. G06F 17/60

(52) U.S. Cl. 705/26; 705/64

(57) ABSTRACT

An apparatus, method, and computer readable storage medium for integrating an electronic purchasing system with a plurality of financial systems. The method includes (a) decoding transaction data representing a transaction, from a transaction database, using a parameter based mapper directed to a selected application system selected from a plurality of application systems; and (b) transferring the decoded transaction data to the selected application system.

### BACKGROUND OF THE INVENTION

1. Field of the Invention

The present invention relates to a method, apparatus, and computer readable storage for integrating an electronic procurement system with multiple application systems. More particularly, the present invention allows an e-procurement system to transmit and interact with one of a plurality of application systems, even though each application system has different communications or data protocols.

2. Description of the Related Art

Electronic procurement (or purchasing) systems allow an entity (such as a government or private/business entity) to conduct transactions such as browsing for, selecting, approving, and actually purchasing goods from a supplier. The entity can typically be a department of the government, private business structure, or any other type of organization or entity that purchases goods. For example, the entity can represent a government agency, departments within the government agency, or individuals within a department.

The electronic transactions for the entity can be managed by an e-procurement system. The e-procurement system can be responsible for many functions, including implementation of workflow and business rules, retrieval of catalogs, and communication with financial systems in order to make an actual purchase. Financial systems can be used to manage and track financial resources, and can include an Enterprise Resource Planning (ERP) system. For example, if an entity wants to purchase office supplies, the entity would typically need to communicate fields such as the purchase price, supplier, account numbers, etc . . . , for the purchase to a financial system in order to obtain the funds necessary for the purchase. Examples of transactions carried out by a financial system can include encumbering funds, making electronic payment to the supplier, electronically transferring funds, etc.

One type of business rule is a rule that an entity (for example government or private) must apply before making a purchase. For example, “anyone in the company who buys a computer must be routed to the technology department for approval” is an example of a business rule. A workflow represents an approval chain, in which successive parties must obtain approval in succession before the purchase is approved. For example, “all purchases over $100 must first be approved by the department head and then by John” is an example of a workflow. Note that a workflow is a special kind of business rule. A business rule may be a workflow, if it contains an approval chain.

FIG. 1A is a block diagram illustrating a simplified example of a typical electronic purchasing system implementing business rules and workflow of the prior art.

Referring now to FIG. 1A, a buyer 1 104 communicates a purchase request to the e-procurement system 100 via a computer communications network 103 or communication line 103. The e-procurement system 100 includes business rules and workflow storage 101 for the buyer 104. The e-procurement system 100 also contains catalog storage 115 and a network engine 114. The network engine 114 is used to communicate with suppliers and receive catalog information, which in turn is stored in the catalog storage 115. Assuming that a particular purchase request by the buyer 1 104 requires approval from approver 1 106, the e-procurement system 100 sends an approval request to approver 1 106 via a communication line 105. The approval request is typically sent via e-mail, although any communication method, such as voice mail or paper mail, can be used. Approver 1 106 sends his or her approval back to the e-procurement system 100 via the communication line 105.

If approver 1 did not approve the purchase request, then the e-procurement system 100 sends back a denial to buyer 1 104 via the communications line 103. Assuming approver 1 approves the purchase order, the e-procurement system 100 sends financial information regarding a purchase request to a financial system 1 112 via communication line 111 in order to arrange for securing the funds and arrange payment to the supplier.

The e-procurement system 100 also sends purchase information regarding the purchase request to a supplier 110 via a computer communications line 109. The purchase information can typically include information such as the items desired for purchase, quantity, etc. The financial system 1 112 sends payment information to the supplier 110 via a computer communication line 113, which can include electronic payment.

Similarly, buyer 2 109 also can make a purchase request to the same e-procurement system 100. Note however, that buyer 2 109 may have different business rules and workflow that buyer 2 109 must abide by (as opposed to other buyers using the e-procurement system 100 such as buyer 1 104). In the case of FIG. 1A, buyer 2 109 needs approval from approver 2 108, before the purchase request by buyer 2 109 is approved. Buyer 2 109 also requires interaction with financial system 1 112 via the e-procurement system 100 via communication line 111.

Note that buyer 1 104 and buyer 2 109 both belong to organization A 116, which requires interaction with financial system 1 122. An organization can be an entire business or government entity, a subset of an entity, or even a single person. In FIG. 1A, all members of organization A 116 who create transactions via the e-procurement system 100 require interaction with financial system 1 122.

Many financial or ERP systems exist. However, each such financial system requires a different database structure, communication protocol, or “handshake” for communicating with e-procurement systems. If it was desired to integrate with a new financial system, the prior art afforded no easy and efficient way to achieve such an integration.

FIG. 1B is a diagram illustrating one approach the prior art uses to allow different buyers from different organizations, each organization requiring interaction with an e-procurement system and a different financial system. The approach illustrated in FIG. 1B is a “dedicated system” or “unhosted model” approach, wherein an additional e-procurement system is used for each organization.

Referring now to FIG. 1B, buyer 1 118 belongs to organization A 117. Buyer 2 122 belongs to organization B 121. Organization A 117 requires interaction with financial system 1 120, while organization B 121 requires interaction with financial system 2 124. Note that this situation is in contrast to FIG. 1A, where both buyers interacted with the same financial system because they are from the same organization. Buyer 1 118 communicates with e-procurement system 1 119, which implements transactions with financial system 1 120. Similarly, buyer 2 122 communicates with e-procurement system 2 123, which implements transactions with financial system 2 124.

The unhosted model implementation illustrated in FIG. 1B is disadvantageous in that an entire e-procurement system is dedicated to each organization. This can be a waste of resources in that each e-procurement system 119, 123, may not use all of its own resources. Hypothetically, the resources used by both e-procurement system 1 119 and e-procurement system 2 123 may be small enough to run on only one e-procurement system, instead of two.

FIG. 1C is a diagram illustrating a “hosted” model. The e-procurement system 125 maintains multiple executables (or instances) for each of buyer 1 127 and buyer 2 129. Typically, in the hosted model, each buyer would have a dedicated executable or instance (an instance could be defined as an executable process running in memory of an e-procurement application).

Referring now to FIG. 1C, buyer 1 127 has executable 1 131 dedicated to processing transactions for buyer 1 127 and organization A 138. Executable 1 131 interfaces with financial system 1 135, using special routines written to properly communicate with financial system 1 135. Similarly, buyer 2 129 has executable 2 133 dedicated to processing transactions for buyer 2 129 and organization B 139. Executable 2 133 interfaces with financial system 2 137, using special routines written to properly communicate with financial system 2 137.

Thus, even though buyer 1 127 belongs to organization A 138 which requires financial system 1 135, and buyer 2 129 belongs to organization B 139 which requires financial system 2 137, both buyers can still share the same e-procurement system 125.

However, the problem with the configuration as illustrated in FIG. 1C is that assigning a dedicated executable for each buyer having unique characteristics is inefficient as far as resources are concerned. A typical e-procurement system can only run a limited number of executables at one time. Further, adding new financial systems is difficult because each new financial system has a different protocol that it requires. Therefore, cumbersome programming in the e-procurement system is required in order to accommodate different financial systems.

Therefore, what is needed is an efficient, dynamic and easy way for e-procurement systems to integrate with a plurality of application or financial systems.

### SUMMARY OF THE INVENTION

Accordingly, it is an object of the present invention to provide a method and apparatus for allowing dynamic and efficient integration between an electronic purchasing system and a plurality of financial systems.

Additional objects and advantages of the invention will be set forth in part in the description which follows, and, in part, will be obvious from the description, or may be learned by practice of the invention.

The foregoing objects of the present invention are achieved by providing a method which includes (a) decoding transaction data representing a transaction, from a transaction database, using a parameter-based mapper directed to a selected application system selected from a plurality of application systems; and (b) transferring the decoded transaction data to the selected application system.

In addition, objects of the present invention are also achieved by providing the above methods on a computer readable storage medium instructing a computer to perform the methods.

Moreover, objects of the present invention are achieved by providing an apparatus including (a) an integrator receiving transaction data representing a transaction; and (b) an interface processor implementing the transaction with a selected application system of a plurality of application systems by identifying and communicating the transaction using a data protocol corresponding to the selected application system.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1A is a diagram illustrating an example of a prior art electronic purchasing system implementing business rules and workflow;

FIG. 1B is a diagram illustrating one approach the prior art uses to allow different buyers from different organizations, each organization requiring interaction with an e-procurement system and a different financial system;

FIG. 1C is a diagram illustrating a prior art “hosted” model using multiple executables to allow different buyers from different organizations to integrate e-procurement systems with multiple application systems;

FIG. 2 is a diagram illustrating a hosted model of an electronic procurement system, according to an embodiment of the present invention;

FIG. 3 is a diagram illustrating an example of the relation between electronic procurements systems, an integrator, and financial systems, according to an embodiment of the present invention;

FIG. 4 is a diagram illustrating an example of the apparatus used to implement the present invention, according to an embodiment of the present invention;

FIG. 5 is a diagram illustrating in more detail the apparatus used to implement the present invention, according to an embodiment of the present invention;

FIG. 6 is a diagram illustrating in more detail the integrator, APIs, and financial systems, according to an embodiment of the present invention;

FIG. 7 is a block diagram illustrating in more detail one example of an API system, according to an embodiment of the present invention;

FIG. 8 is a chart illustrating one example of how the mapper file is created, according to an embodiment of the present invention;

FIG. 9 is a flowchart illustrating one example of the actual creation process for the mapper file system, according to an embodiment of the present invention;

FIG. 10 and FIG. 11 are flowcharts illustrating one example of the process of logging on to a financial system, according to an embodiment of the present invention;

FIG. 12 is a flowchart illustrating one example of the process of logging out of a financial system, according to an embodiment of the present invention;

FIG. 13 is a flowchart illustrating one example of the process of opening a document, according to an embodiment of the present invention;

FIG. 14 is a flowchart illustrating one example of the process of editing a document, according to an embodiment of the present invention;

FIG. 15 is a flowchart illustrating one example of a main driver system, according to an embodiment of the present invention;

FIG. 16 is a flowchart illustrating one example of a client manager and processor, according to an embodiment of the present invention;

FIG. 17 is a flowchart illustrating one example of a database adapter system, according to an embodiment of the present invention;

FIG. 18 is a flowchart illustrating one example of a recovery of a bad transaction for use with a financial system, according to an embodiment of the present invention;

FIG. 19 is a flowchart illustrating one example of the process of mapping, according to an embodiment of the present invention;

FIG. 20 is a flowchart illustrating one example of the error manager system, according to an embodiment of the present invention.

### DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

The present invention facilitates an electronic procurement system (“e-procurement system”) to interact and transact with a plurality of application systems or financial systems.

An e-procurement system is an automatic system, implemented by a computer, which allows a buyer to conduct any type of purchase from an electronic catalog system. An e-procurement system can also implement workflow and business rules for a particular buyer before approving and implementing a transaction.

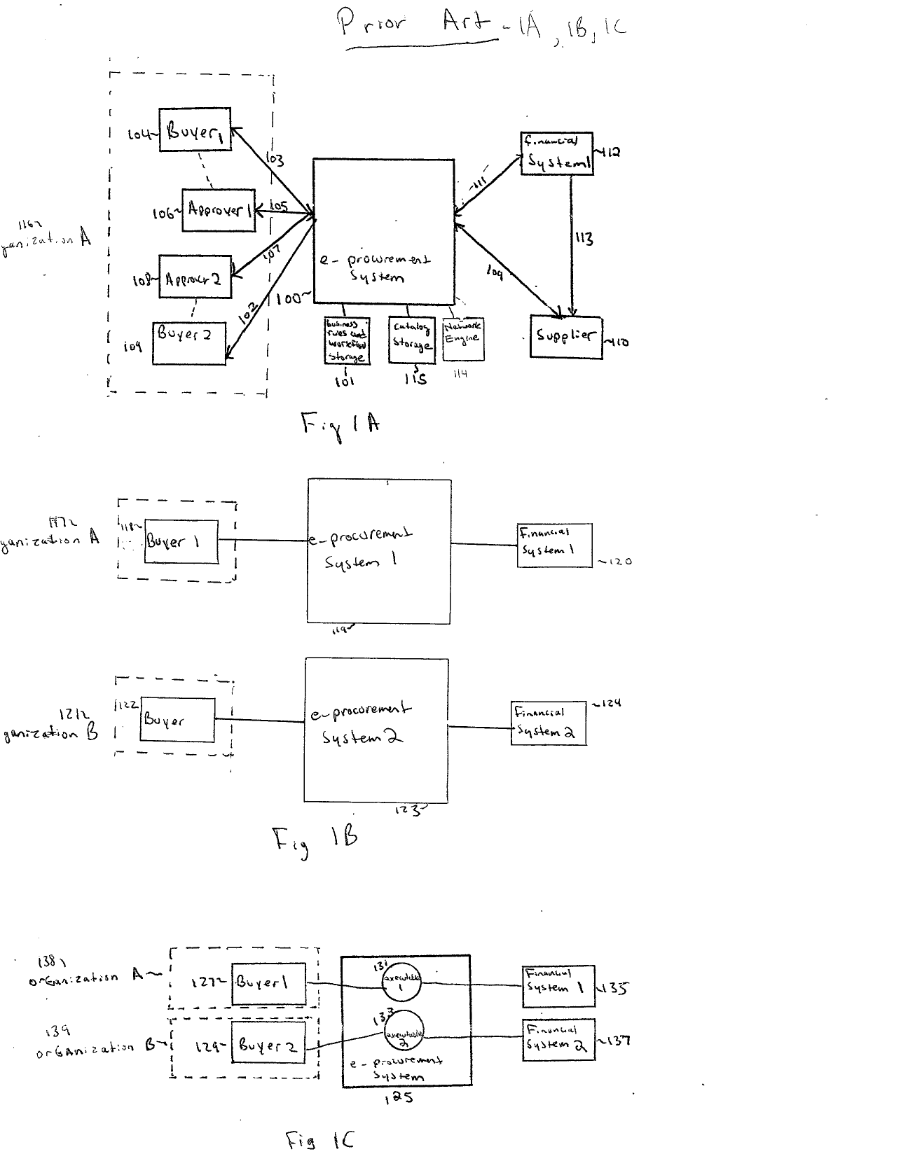

An e-procurement system would typically include a catalog storage, a database system electronically connected a network engine. The network engine would typically be connected to a plurality of suppliers. For example, Ariba Inc. provides a commercially available e-procurement system, which can be used as e-procurement system (FIG. 1, 100). The Ariba Network is an example of a commercially available network engine that can be used as the network engine (FIG. 1, 114). Commerce One and Intelisys are other companies that provide commercially available electronic procurement systems.

An application system is a system which an e-procurement system communicates with and performs an operation at the request of the e-procurement system. An example of an application system that may need to interact with an e-procurement system would be an inventory system. Another example of an application system is a financial system, which is used to track and manage financial resources. For example, a financial system can establish financial obligation for the purchase, encumber funds, etc.

While electronic procurement systems and financial systems have been widely used, electronic procurement systems in the past have suffered from a lack of scalability. Adding buyers from new organizations with different business rules and financial systems results in difficulties accommodating the new buyers and financial systems in terms of hardware and software.

In order to avoid the disadvantages of using multiple executables of an e-procurement application for different buyers as illustrated in FIG. 1C, a “shared executable hosted system” can be used.

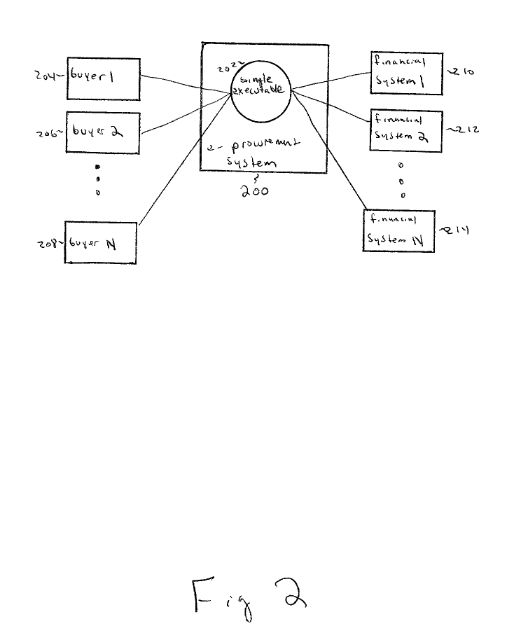

FIG. 2 is a diagram illustrating a shared executable hosted model of an e-procurement system using the technology of the present invention. A shared executable hosted system is an e-procurement system in which multiple buyers from multiple organizations can use the system without having to use multiple executables as illustrated in FIG. 1C.

Referring now to FIG. 2, buyer 1 204, buyer 2 206 . . . buyer N 208 all access the e-procurement system 200. Each buyer has a unique set of business rules, workflow, associated information, and an associated financial system. In this example, each buyer belongs to a different organization and is associated with a different financial system. All of each buyer's unique information is stored on the e-procurement system 200. Buyer 1 204 utilizes financial system 1 210, while buyer 2 206 utilizes financial system 2 212, and buyer N 208 utilizes financial system N 214.

Instead of the multiple executables all running as illustrated in FIG. 1C, the shared executable hosted e-procurement system 200 has a single executable 202 processing buyer 1 204, buyer 2 206 . . . buyer N 208. One example of a shared executable hosted system is BUYSENSE.COM, available from AMERICAN MANAGEMENT SYSTEMS.

There are many advantages of the shared executable hosted system over the prior art system as illustrated in FIG. 1C. The prior art system may run out of resources if too many unique buyers attempt to use the system, as each executable requires system resources such as memory and processor time. However, the shared executable hosted system can handle a large number of unique buyers because the hosted system preserves resources by limiting the number of executables running on the e-procurement system. In addition, a company that may not have enough money to purchase an entire e-procurement system, nevertheless can “share” space on a shared executable hosted system for a cheaper amount than buying an entire system. A hosted method can also be more cost-effective for companies because one possible revenue model can be used that is based on the number of transactions processed. For example, companies with a smaller number of purchases only pay for each transaction on a transaction by transaction basis.

Another problem solved by the present invention is that of “integrating” between an e-procurement system and financial systems. As stated above, each application or financial system has a unique protocol in order to carry out transactions with it. “Protocol,” as used herein, refers to any information relevant to communicating with the application or financial system, and can include (but is not limited to) concepts such as handshake, database architecture, database structure, etc.

An integrator is used in order to communicate a transaction effectively between an e-procurement system and an application system. The integrator receives a requested transaction, typically from an e-procurement system, and implements the transaction with an application system that the transaction is intended to be carried out with. The integrator described herein is especially useful for the hosted model or the shared executable hosted model, in which multiple financial systems are to be accessed by a single executable of an e-procurement system. However, the integrator described herein can also be used with any e-procurement system, regardless of whether it is an unhosted, hosted, or shared-executable hosted model.

While the integrator is able to implement transactions between an e-procurement system and multiple application systems, the integrator can also implement transactions between multiple e-procurement systems and multiple application systems. Thus, in one embodiment of the present invention, different e-procurement systems can “share” an integrator, resulting in a more efficient use of resources.

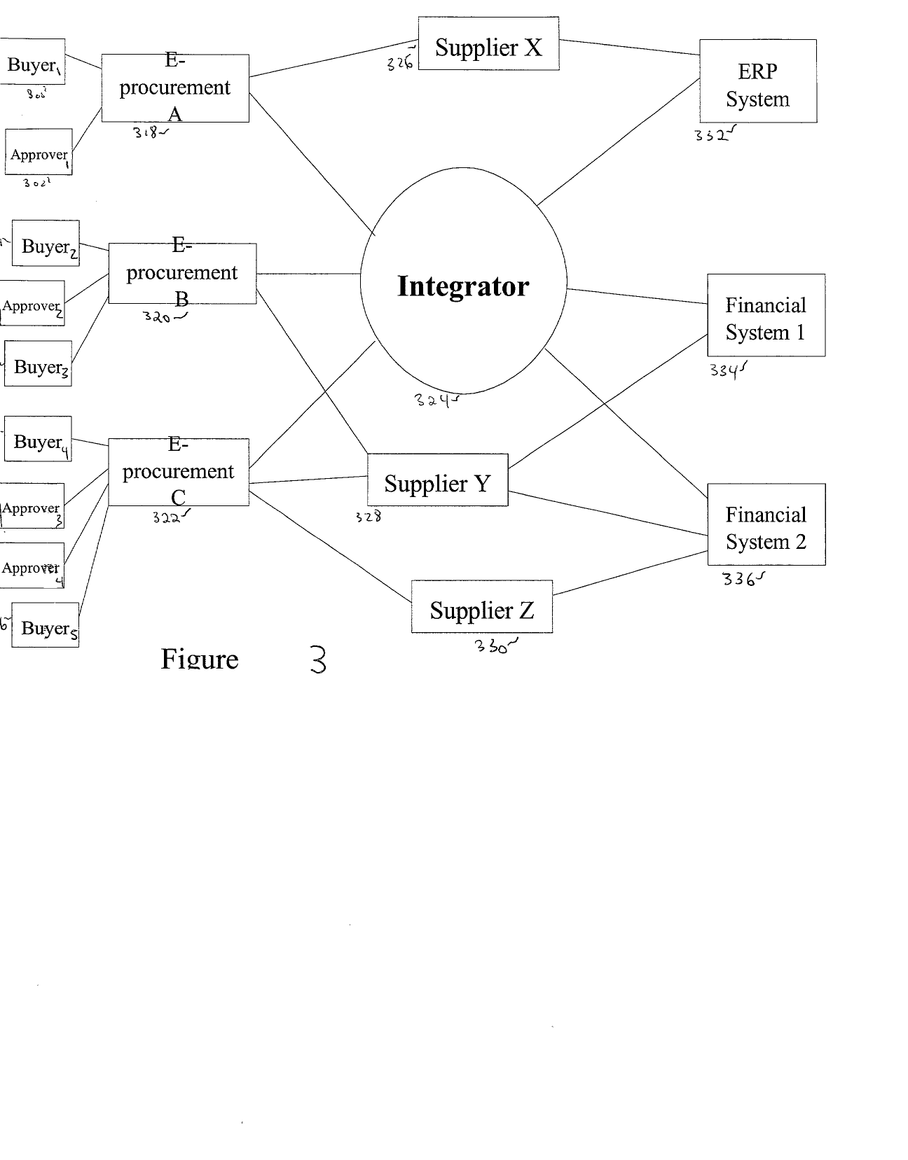

FIG. 3 is a diagram illustrating an example of the relation between electronic procurements systems, an integrator, and financial systems.

Referring now to FIG. 3, buyer 1 300 and approver 1 302 are associated with e-procurement system A 318 and ERP system 332. When buyer 1 300 wants to make a purchase, e-procurement system A 318 carries out the workflow and business rules for buyer 1 300. Assuming that a purchase request by buyer 1 300 requires approval from approver 1 302, e-procurement system A 318 requests approval from approver 1 302. Upon proper approval from approver 1 302, e-procurement system A 318 transmits the purchase request to supplier X 326. Assuming that purchase preferences of buyer 1 300 require that the ERP system (a financial system) 332 that buyer 1 300 uses send electronic payment to supplier X 326. E-procurement system A 318 then needs to interface with ERP system 332 in order to secure the electronic payment. The integrator 324 is used in order to translate a given transaction between e-procurement system A 318 and ERP system 332. E-procurement system A 318 stores a transaction that is read by the integrator 324. The integrator 324 interacts with the ERP system 332 and completes the transaction. The ERP system 332 then typically sends the electronic payment to supplier X 326.

Similarly, buyer 2 304, buyer 3 308, and approver 2, 306 are associated with e-procurement system B 320 and financial system 1 334. E-procurement system B 320 also uses integrator 324 in order to transact with financial system 1. 334. E-procurement system B 320 and financial system 1 334 both communicate with supplier Y 328.

Similarly, buyer 4 310, buyer 5, 316, approver 3 312, and approver 4 314 are all associated with e-procurement system C 322 and financial system 2 336. E-procurement system C also uses integrator 324 to transact with financial system 2 326. E-procurement system C 322 and financial system 2 336 both communicate with supplier Y 328 and supplier Z 330.

Alternatively, buyer 4 310 and buyer 5 316 can be from different organizations. For example, buyer 4 310 may need to interact with financial system 1 334, while buyer 5 316 may need to interact with financial system 2 336. Thus, different buyers from different organizations, which access different financial systems, can use the same e-procurement system and the same integrator to access their respective financial system.

Therefore, as can be seen by FIG. 3, the integrator 324 is used between the e-procurement systems and the intended ERP and financial systems. Even though each of the ERP or financial systems illustrated have their own unique protocols, each e-procurement system can rely on the integrator in order to carry out the particular interactions with the financial or ERP systems.

The e-procurement systems and the financial or ERP systems can typically all communicate with all of the suppliers, not just particular ones.

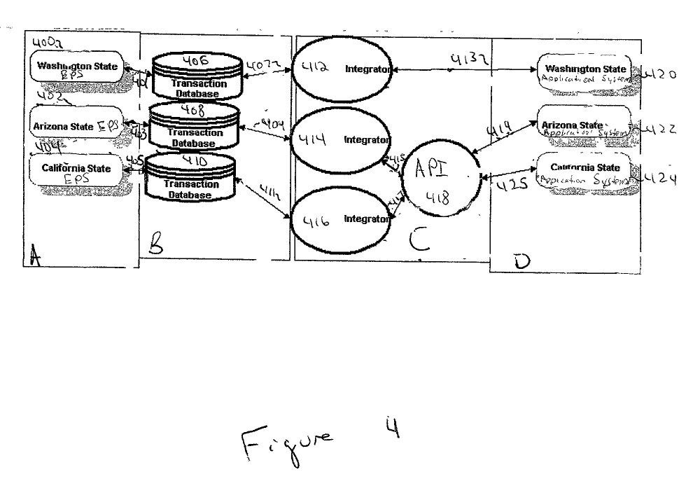

FIG. 4 a diagram illustrating an example of the apparatus used to implement the present invention, according to an embodiment of the present invention, which allows efficient integration of the e-procurement system with a plurality of financial system.

Referring now to FIG. 4, block A of FIG. 4 represents three e-procurement systems 400, 402, 404. Each e-procurement system (“EPS”) runs an e-purchasing system for a different organization (i.e. Washington State, Arizona State, and California State).

Block B of FIG. 4 represents three transaction databases 406, 408, 410, for each of the respective e-procurement systems 400, 402, 404, connected by respective computer communication lines 401, 403, 405. The transaction databases 406, 408, 410, receive data from the respective e-procurement system 400, 402, 404 containing information regarding a desired transaction (“transaction information”) with a financial system.

For example, if e-procurement system 404 desires to request from a financial system an encumbrance of $1000 for a particular bank account, the e-procurement system 400 will transmit this transaction information using a mapper file (to be discussed below) to transaction database 410 via computer communication line 405.

Block C in FIG. 4 represents integrators, which serve to read transaction information from their respective transaction database and interact with a financial system in accordance with a financial system's unique protocol or database structure/architecture. The integrators 412, 414, 416 are connected to their respective transaction databases 406, 408, 410, by computer communications lines 407, 409, 411, respectively. Note that in this embodiment, unlike the example in FIG. 3, there are separate integrators for each e-procurement system. In the alternative, one integrator instead of three could have been used instead. The integrators continuously poll their respective transaction database to see if transaction information is present and ready to be processed.

After transaction database 410 stores a transaction, the polling by integrator 416 of transaction database 410 via communication line 411 confirms that a ready transaction information is waiting. The integrator 416 then reads (decodes) the transaction information using a mapper file (to be discussed below).

Integrators 414, 416 are connected to API 418 (Application Program Interface). An API, generally, is needed for each particular type of financial system in order to transmit and receive data from the financial systems using a protocol (or handshake) that the financial systems require. One example of an API is Javantage, from AMERICAN MANAGEMENT SYSTEMS. Javantage receives the transaction data from the integrator and implements the transaction with any ADVANTAGE financial system. ADVANTAGE financial systems are available from AMERICAN MANAGEMENT SYSTEMS. ADVANTAGE Connect is a program that runs in conjunction with Javantage and is used to communicate with the ADVANTAGE financial system.

Block D of FIG. 4 represents target application systems 420, 422, 424, connected to integrator 412, API 418, and API 418, respectively, via communications lines 413, 419, 425. Note that while in FIG. 4 integrators 414, 416 are connected to the same API 418, typically each integrator would not be sharing the same API, but instead each integrator would have its own copy of each API.

Continuing our example above, when the API 418 is executed, it interfaces with the application system 424. The API 418 transmits the transaction information received from the integrator 416 in the proper format in order that the transaction can successfully be carried out with the application system 424. Typically, interfacing with an application system may require an “interactive” exchange of data, in that data is not simply transmitted all at once. For example, before transmitting each field, a confirmation may need to be received from the financial system that the previous field was accepted. The API is programmed to handle such interactive exchanges, and can for example be written in a language such as Java.

Some application systems may not require an interactive handshake but instead can accept the data all at once. For such systems, the integrator can transmit the transaction information directly to the application system in a “flat file.” For example, integrator 412 transmits transaction information directly to application system 420, via communication line 413. In the alternative, some application systems may require a flat file to still be transmitted using an API.

Now we will address the actual form that data takes at different points along the integration process. For example, suppose the e-procurement system requests that a transaction is conducted with a particular financial system. The transaction data for the request includes $10,023.89 from account #10011 from the office supply store “STAPLES” with a purchase identification of “DOC 111”.

TABLE I

| UniqueName = | DOC111 |
|---|---|
| Supplier = | STAPLES |
| Account = | 10011 |
| TotalCost = | 10,023.89 |

Table I illustrates one example of how this data is actually stored in the e-procurement system. The e-procurement system uses the variable (or field name) “UniqueName” which stores “DOC 111.” The variable “Supplier” is used to store “STAPLES.” The variable “Account” is used to store 10011. The variable TotalCost is used to store $10,023.89. The transaction data takes this form in block A of FIG. 4.

As discussed above, the transaction data is stored on the transaction database. The e-procurement system uses a parameter (or table driven) “mapper file” in order to store this data on the transaction database in a predefined format for later retrieval by the integrator.

TABLE II

<field>

<ormsname=UniqueName/>
<erpname=DocumentNumber/>
<length=6/>
<offset=1/>

</field>
<field>

<ormsname=Supplier/>
<erpname=Vendor/>
<length=10/>
<offset=7/>

</field>
<field>

<ormsname=Account/>
<erpname=Fund/>
<length=5/>
<offset=17/>

</field>
<field>

<ormsname=TotalCost/>
<erpname=Amount/>
<length=14/>
<offset=22/>

</field>

Table II is one example of a mapper file, this particular example is written in XML. However, other protocols besides XML can be used as well. The mapper file is created for a particular target ERP or financial system. The mapper file is a file used to define a first set of variables (or fields) with their respective values into a second set of corresponding variables, so that the values can be passed to the second set of variables. In the case of Table II, the mapper file is “parameter based,” (or “table driven”) in that the mapper is defined by actual parameters (or tables), as opposed to a “hard coded” mapper which would require an executable program specifically written to perform the mapper. The parameters can be considered characteristics of each set of variable.

TABLE III
“DOC1111STAPLES 1001110023.89”

When the e-procurement system applies the mapper file of Table II to the transaction data of Table I, the result is the data file illustrated in Table III, which is stored on the transaction database. The mapper file includes four fields. Each field includes: a field name used by the e-procurement system “ormsname,” a field name used by the financial system “erpname,” a length of the particular field “length,” and the offset of the particular field “offset.” Thus, the e-procurement system starts with the first field in the mapper file, which is “UniqueName.” Since the e-procurement system has the UniqueName variable equal to “DOC111,” the e-procurement system creates a file starting with “DOC111.” No spaces are needed since the length of this first field in the mapper file is 6 characters, which corresponds to the length of “DOC 111.” Then the e-procurement system proceeds to the next field in the mapper file, which is “Supplier.” Since the e-procurement system has the Supplier variable equal to “STAPLES,” the e-procurement system appends the data file with “STAPLES.” Since “STAPLES” is 7 characters while the field length is 10, 3 extra spaces are added to the end of “STAPLES.” This process repeats for all of the fields in the mapper file.

When the above process is done for all four fields in the example mapper file, the result is the file shown in Table III. This file is stored on the transaction database. Thus, the transaction data in block B of FIG. 4 takes this form.

As stated above, the integrator is continuously polling the transaction database for a transaction file which is ready to be processed. When the file illustrated in Table III is stored on the transaction database and ready to be processed by the integrator, the integrator typically uses a copy of the same mapper file as illustrated in Table II to read the transaction data.

The integrator implements a similar but reverse process of the previous process, which reads the fields in the data file using the mapper file and assigns the appropriate values to the proper variables.

TABLE IV

| DocumentNumber = | DOC111 |
|---|---|
| Vendor = | STAPLES |
| Fund = | 10011 |
| Amount = | 10,023.89 |

Table IV is an example of the results when the mapper file in Table II is applied to the transaction data in Table III. Table IV is the form the data takes in Block C of FIG. 4.

The integrator starts by reading the first field in the mapper file, which designates that the variable name is “DocumentNumber,” length is 6, and offset is 1. Therefore, the integrator reads the transaction data file from the transaction database and locates characters 1-6, which is “DOC111.” Then, DocumentNumber is set equal to “DOC111.” This process continues for all of the fields in the mapper file.

The result of the above-described mapper is that even though the e-procurement system and financial system uses different names, data types, lengths, etc. to describe corresponding fields, nevertheless the mapper file allows the e-procurement system to properly pass the needed fields to the financial system.

While Tables I, II, III and IV and the above description describe one approach to mapping, it can be appreciated that the mapping between an e-procurement system and an application system can be accomplished using other methods as well.

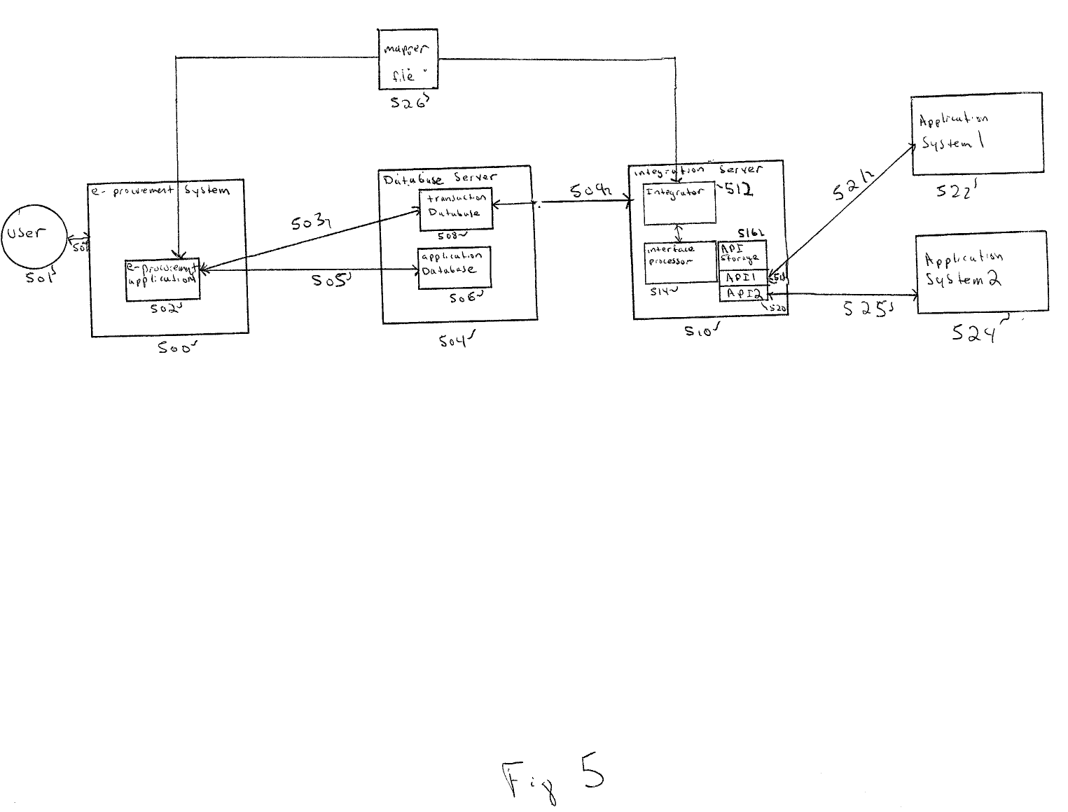

FIG. 5 is a block diagram illustrating in more detail the apparatus used to implement the present invention.

Referring now to FIG. 5, a user 501 connects with the e-procurement system 500 via communication line 507. The e-procurement system 500 includes an e-purchasing application 502 which is an application program running on the e-procurement system 500 which implements all of the operations of a typical e-procurement system, such as executing the business rules and workflow, etc. The particular business rules, workflow, and any other relevant information for each user is stored in the application database 506, via communication line 505.

When the user 501 requests a transaction from the e-procurement system 500, and the transaction is approved by the e-procurement application 502 (and the transaction requires a transaction with a financial system), then a mapper file 526 is used to create (or encode) transaction data which is stored on a transaction database 508 via communication line 503. When the transaction data is completed and ready for processing by integrator 512, the transaction data stored on the transaction database 508 typically includes a flag such as “READY” indicating that data is ready to be processed. The integrator 512 continuously polls the transaction database 508 via communication line 509 until the integrator 512 finds transaction data that is ready to be processed. When such transaction data is found, then the mapper file 526 is used to decode the transaction data from the transaction database 508. Note that copies of the same mapper file 526 are stored on the e-procurement system 500 and the integration server 512.

The transaction data, in addition to the fields required for the financial systems, may also have associated tags designating system information. For example, a tag can be associated with the transaction data identifying which particular mapper file the transaction data is to be encoded/decoded with. Tags can also include transaction type, identification of the destination financial system, client name, and any other information needed in order that the transaction data can be processed and delivered properly.

After the integrator 512 decodes the transaction data using the mapper file 526, then the integrator 512 uses an interface processor 514 which implements the transaction with the appropriate application system. The interface processor 514 checks if the target application system data requires running an API. One way this check can be implemented is by using an API tag associated with the transaction. If an API is not required, then the decoded transaction data can be transmitted by the interface processor 514 directly to a financial system in a flat file (not pictured). If an API is required, then the proper API is identified by the interface processor 514, typically from a tag specifying the target financial system. The proper API is loaded from API storage 516 and executed by the interface processor 514. For example if application system 1 is being accessed, then the interface processor 514 executes API 1 518 from the API storage 516. API 1 518 is executed and the proper interaction and exchange of the decoded data is carried out between the API 1 518 and application system 1 522, via communication line 521, is carried out. Similarly, if application system 2 is being accessed, then the interface processor 514 executes API 2 520 from the API storage 516. API 2 520 is executed and the proper interaction and exchange of the decoded data is carried out between the API 2 520 and application system 2 524, via communication line 525.

As illustrated in FIG. 5, integration with multiple financial systems can be achieved by using the integrator described herein, which would typically store numerous APIs for different application or financial systems.

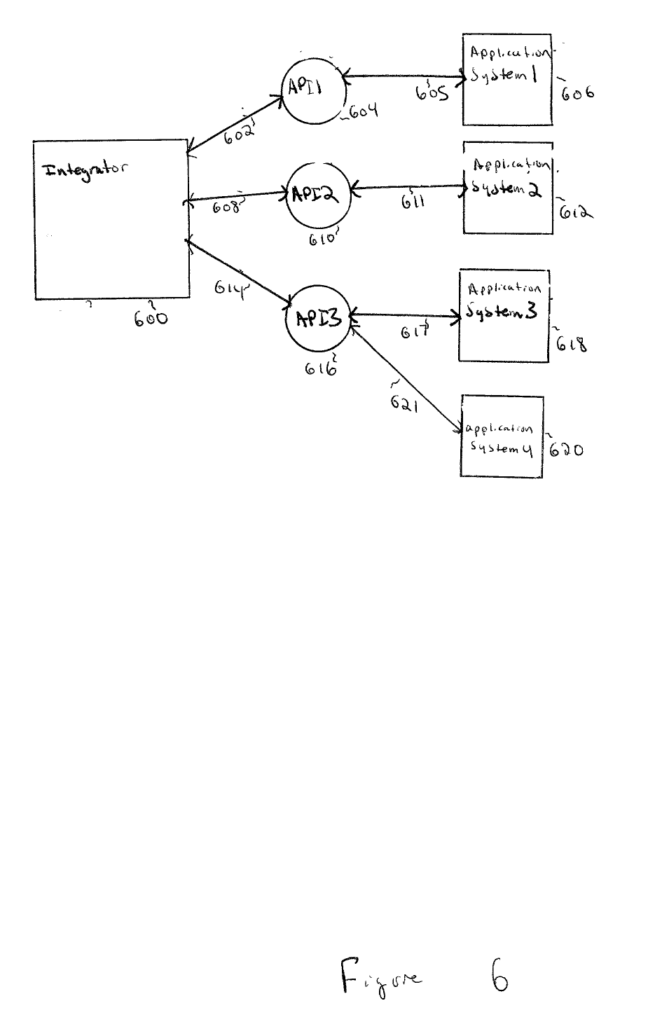

FIG. 6 is a block diagram illustrating in more detail the integrator, APIs, and financial systems, and shows the correspondence between the APIS's and financial systems.

Referring now to FIG. 6, the integrator 600 calls an appropriate API based on information associated with the transaction data, such as a tag. Typically, APIs are written for one specific financial system, although it is possible that one API may actually work for more than one financial system. As an example of a commercially available API, JAVANTAGE is an API that integrates with all Advantage financial systems. The APIs are typically stored on the integrator.

If the integrator 600 determines that the transaction information is intended for application system 1 606, then the integrator determines that API 1 604 is needed. The integrator 600 transmits the decoded transaction information to API 1 604 via communication line 602. API 1 604 then interacts with financial system 606 via communication line 605. Upon completion of the transaction, API 1 604 can transmit back to the integrator 600 via communication line 602 an indication that the transaction was carried out successfully (or unsuccessfully).

Similarly, to interact with application system 2 612, the integrator 600 transmits decoded transaction data to API 2 610 via communication line 608. API 2 610 then interacts with application system 2 612 via communication line 611. Similarly, to interact with financial system 3 618, the integrator 600 transmits decoded transaction data to API 3 616 via communication line 614. API 3 616 then interacts with application system 3 618 via communication line 617. Additionally, API 3 616 interacts with application system 4 620, via communication line 621. In order for application system 3 and application system 4 to use the same API 3 616, these two application systems must use the same protocol.

The figures that follow are intended to help one of ordinary skill in the art implement the claimed invention. While it can be appreciated that one of ordinary skill in the art can implement the present invention in a number of ways, the figures that follow represent merely one possible approach.

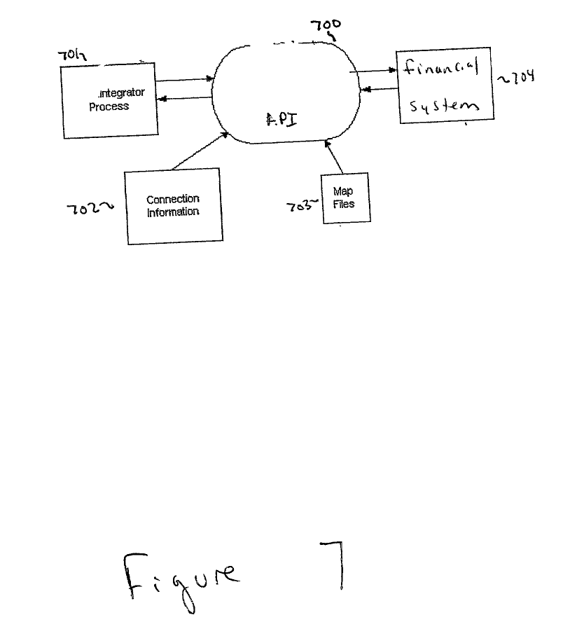

FIG. 7 is a block diagram illustrating in more detail one example of an API. One example of the particular API 700 illustrated in FIG. 7 can be “Javantage/ADVANTAGE Connect,” and one example of the particular financial system 704 illustrated in FIG. 7 can be ADVANTAGE. Javantage/ADVANTAGE Connect is designed to interact with ADVANTAGE, which is a financial system from AMERICAN MANAGEMENT SYSTEMS. Javantage uses ADVANTAGE Connect in order to be able to transmit information to and from ADVANTAGE.

Referring now to FIG. 7, the API receives a request from the integrator process 701, along with the name of the e-procurement system that made the request. The API 700 then uses a database (not pictured) to retrieve connection information 702. Using the connection information 702, the API 700 then connects to financial system 704. After making the connection, the API 700 then reads the map files 703 and interacts with financial system 704 according to the information derived using the map files 703. If errors occur in financial system 704 then the API 700 is notified of these errors, and in turn the API 700 notifies the integrator process 701 of these errors.

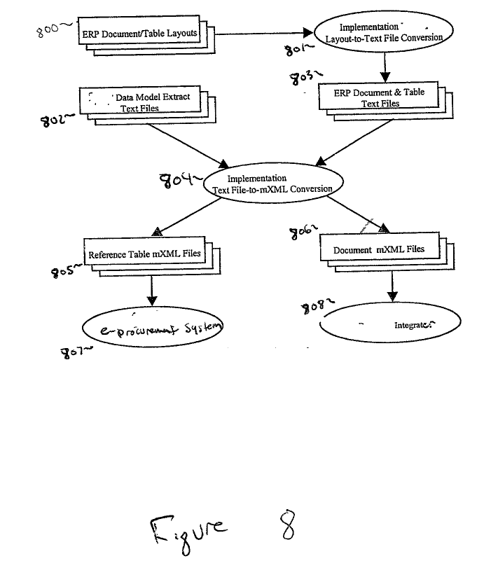

FIG. 8 is a chart illustrating one example of how the mapper file is created.

First, ERP (or financial system) document/table layouts 800 are analyzed to determine which financial documents transactions (i.e. requisitions, purchase orders, etc.) will need to be integrated with the e-procurement system. Corresponding reference table data (i.e. funds, agency, departments, etc.) to support these transactions are also identified. An implementation layout-to-text file conversion 801 program is used to execute utilities that convert the ERP document and table layouts 800 into text file(s) that list the data fields found in the documents and table in ERP document & table text files 803. Pre-defined text files that describe the equivalent tables in the e-procurement application object model are pictured in FIG. 8 as e-procurement data model extract text files 802. Both the ERP document & table text files 803 and the data model extract text files 802 are inputted into an implementation text file-to-mXML conversion program 804. The implementation text file to-mXML conversion program 804 reads each ERP text file, prompts the user to match each ERP data field to a corresponding data field from the e-procurement system and a mXML file is generated as output. During this process, depending on the field, the user may also be prompted to specify default values and other generic field properties. This is repeated for each ERP text file until mXML files are created for each input document and table text file. The implementation text file-to-mXML conversion program 804 creates reference table mXML files 805 and document mXML files 806. The reference table mXML files 805 are then stored in the e-procurement system 807. The Document mXML files are stored in the integrator 808.

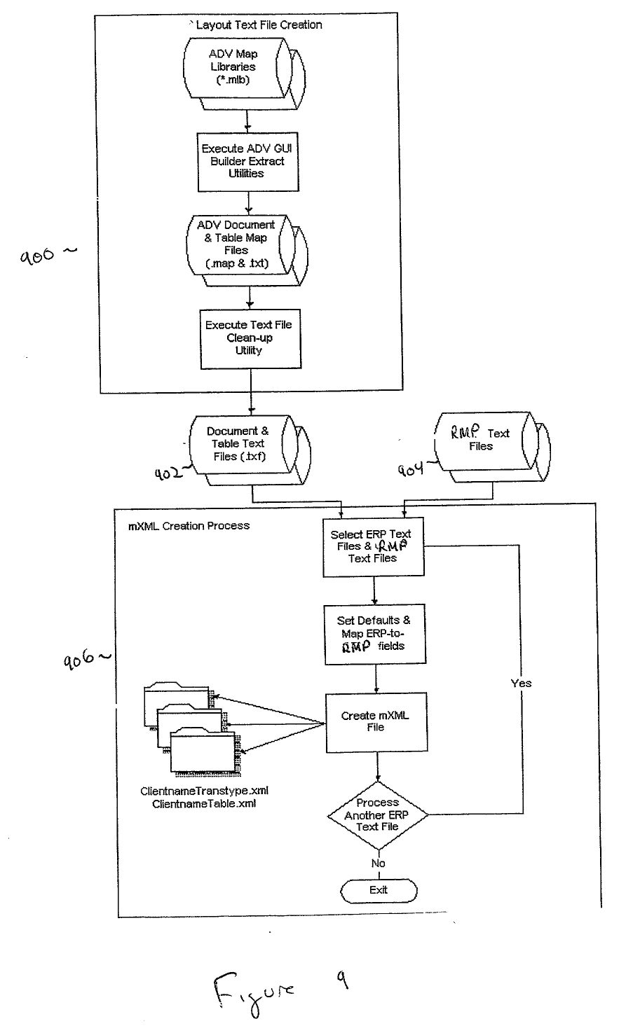

FIG. 9 is a flowchart illustrating one example of the actual creation process for the mapper file. Block 900 represents operations performed in the ERP layout text file creation. While the operations listed therein can be used for the ADVANTAGE ERP, it can be recognized by one of ordinary skill in the art that similar operations can be applied to any ERP, financial, or target system.

Regarding block 900, typically financial systems such as ADVANTAGE are delivered with map libraries (*.mlb) which are a compilation of the individual map files for each document and table found in the financial system. The individual maps (*.map) which describe the record layouts of the documents and tables can be extracted from the map libraries and converted to text files (*.txt) using simple utilities also typically provided.

The text files are then stripped of extraneous information such as file description, column titles, and field display attributes and the remaining data is put into a standard format understood by a mapper creation program. In a financial system such as ADVANTAGE, documents are mapped using three different files: one for the batch header, one for the document header, and one for the document lines. The tables are mapped using only one file, and a corresponding “.txf” file is created for each of these. The final result of the operations in block 900 is the document & table text files .txf 902.

In block 906, the mXML mapper file is actually created by a creation program using a document & table text file (.txf) 902 and a text file 904. The text file 904 is similar to the document & table text files (.txf) 902, but for the e-procurement system side. In block 906, the input files are selected, and the creation program displays each data field found in the input file one at a time and all of the elements from its corresponding input file. When a field is selected, its basic properties such as length, type, and offset will also be displayed. Using the “mapper” completed by the user along with the field properties, the program generates the naming convention and the table mXML files.

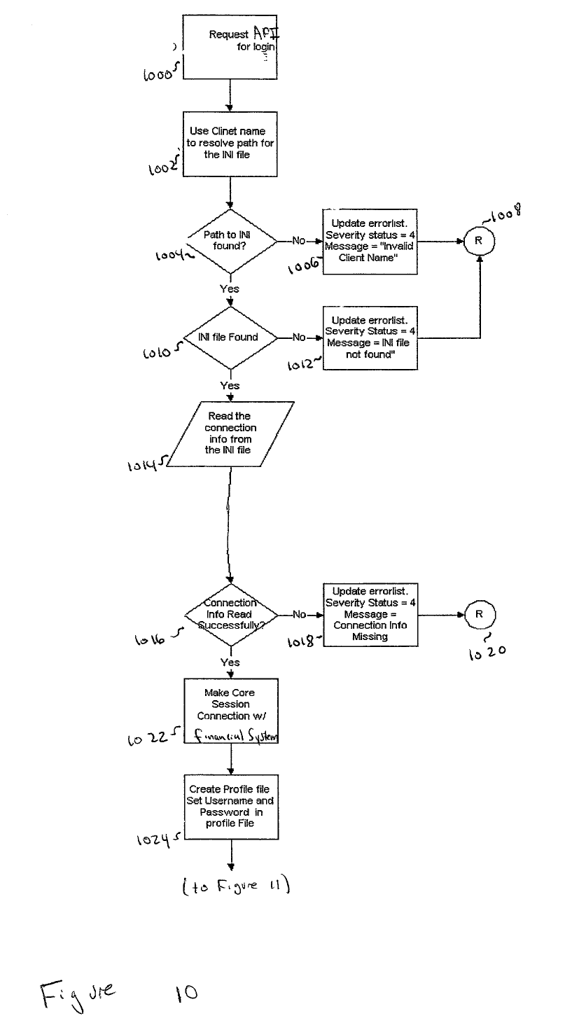

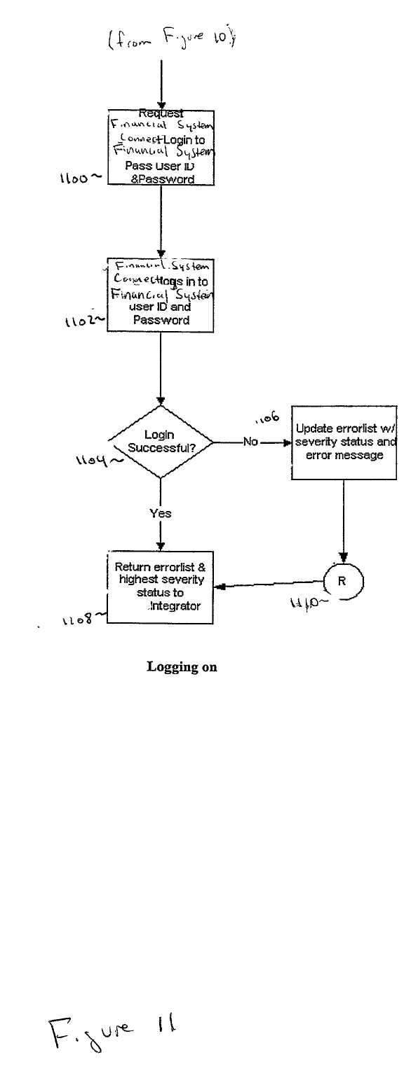

FIG. 10 and FIG. 11. are flowcharts illustrating one example of the process of logging on to the ADVANTAGE ERP. While this flowchart is written particularly for ADVANTAGE, one of ordinary skill in the art will recognize that logging on to other ERP and financial systems would typically entail a similar process.

Referring now to FIG. 10, operation 1000 is first performed which requests the API (for example Javantage/ADVANTAGE Connect) to log in to the financial system (for example ADVANTAGE). From operation 1000 the process proceeds to operation 1002, wherein the client name is used to resolve a path for the INI file. From operation 1002 the process proceeds to operation 1004, wherein a check is performed to see if the path to the INI file is found. If the result from the check in operation 1004 is no, then the process proceeds to operation 1006 wherein an update is performed to the errorlist and severity status is set equal to 4 with a message of “Invalid Client Name” and the process then proceeds to connector 1008, which continues at FIG. 11, connector 1110.

If the result from the check in operation 1004 is yes, then the process proceeds to operation 1010 which performs a check to see if the INI file is found. If the result of the check in operation 1010 is no, then the process proceeds to operation 1012 which updates the errorlist, sets the severity status equal to 4 with a message of “INI file not found” and the process proceeds to connector 1008, which continues at FIG. 11, connector 1110.

If the result from the check in operation 1010 is yes, then the process proceeds to operation 1014 which reads the connection information from the INI file. From operation 1014, the process proceeds to operation 1016 wherein a check is performed to see of the connection information is read successfully. If the result of the check in operation 1016 is no, then the process proceeds to operation 1018 which updates the error list, sets the severity status equal to 4 with a message of “Connection info Missing” and the process proceeds to connector 1020, which continues at FIG. 11, connector 1110.

If the result from the check in operation 1016 is yes, then the process proceeds to operation 1022 which makes core session connection with the financial system. From operation 1022, the operation proceeds to operation 1024, which creates a profile file and sets username and password in profile file. From operation 1024 the process proceeds to FIG. 11, operation 1100, which requests financial system connect to log in to the financial system and passes the user ID and password. Financial system connect is a module which the API uses to connect to the financial system. One example of a financial system connect is ADVANTAGE Connect. From operation 1100 the process proceeds to operation 1102 wherein financial system connect logs in to the financial system with the user ID and password. From operation 1102 the process proceeds to operation 1104 which performs a check to see if the login was successful. If the result of the check in operation 1104 is no, then the process proceeds to operation 1106 which updates errorlist with severity status and error message and proceeds through connector 1110 to operation 1108.

If the result of the check in operation 1104 is yes, then the process proceeds to operation 1108, which returns the errorlist and highest severity status to the integrator.

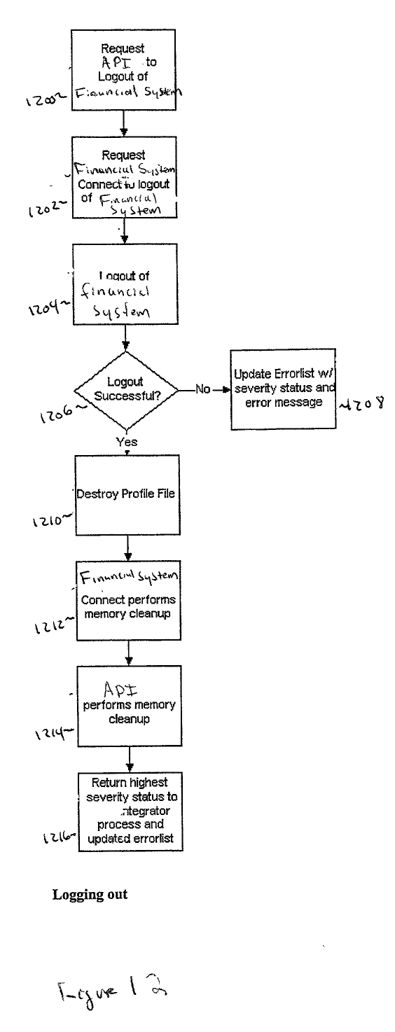

FIG. 12 is a flowchart illustrating one example of the process of logging out of the financial system. While this flowchart is written particularly for ADVANTAGE, one of ordinary skill in the art will recognize that logging out from other ERP and financial systems would typically entail a similar process.

Referring now to FIG. 12, operation 1200 requests the API to log out from the financial system. From operation 1200, the process proceeds to operation 1202, that requests the financial system connect to logout of ADVANTAGE. From operation 1202, the process proceeds to operation 1204 which logs out of the financial system. From operation 1204, the process proceeds to operation 1206 which performs a check whether the logout was successful. If the result of the check in operation 1206 is no, then the process proceeds to operation 1208 which updates the errorlist with severity status and error message.

If the result of the check in operation 1206 is Yes, then the process proceeds to operation 1210 which destroys the profile file. From operation 1210, the process proceeds to operation 1212 wherein the financial system connect performs memory cleanup. From operation 1212, the process proceeds to operation 1214 wherein the API performs memory cleanup. From operation 1214, the process proceeds to operation 1216 which returns a highest severity status to the integrator process and updated errorlist.

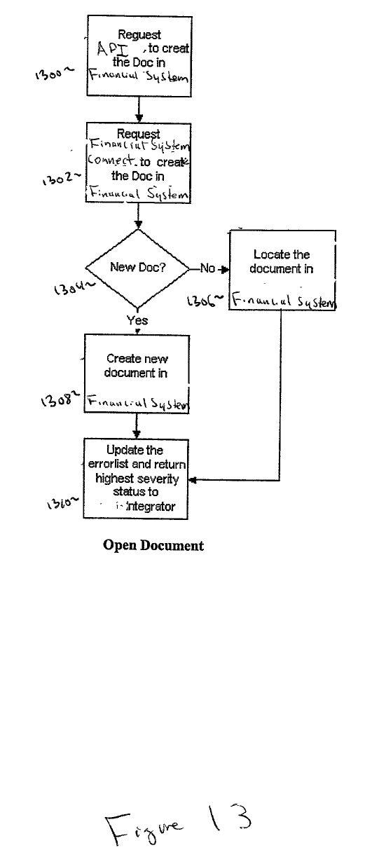

FIG. 13 is a flowchart illustrating one example of the process of opening a document. While this flowchart is written particularly for ADVANTAGE, one of ordinary skill in the art will recognize that opening a document for other ERP and financial systems would typically entail a similar process.

Referring now to FIG. 13, operation 1300 is performed which requests the API to create a document in the financial system. From operation 1300, the process proceeds to operation 1302 which requests the financial system connect to create the document in the financial system. from operation 1302 the process proceeds to operation 1304 which performs a check if this is a new document. If the result of the check in operation 1304 is no, then the process proceeds to operation 1306 which locates the document in the financial system. From operation 1306, the process proceeds to operation 1310.

If the result of the check performed in operation 1304 is Yes, then the process proceeds to operation 1308 which creates a new document in the financial system. from operation 1308 (and operation 1306), the process proceeds to operation 1310 which updates the errorlist and returns highest severity status to the integrator.

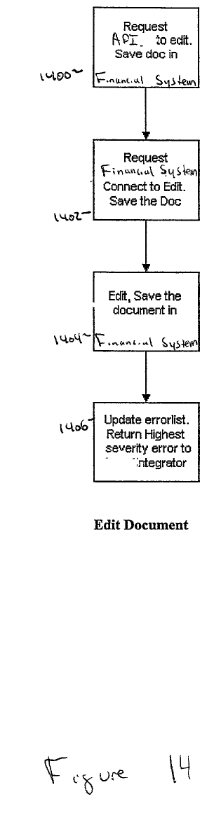

FIG. 14 is a flowchart illustrating one example of the process of editing a document. While this flowchart is written particularly for ADVANTAGE, one of ordinary skill in the art will recognize that editing a document on other ERP and financial systems would typically entail a similar process.

Referring now to FIG. 14, operation 1400 is performed which requests the API to edit, and saves the document in the financial system. From operation 1400, the process proceeds to operation 1402 which requests the financial system connect to edit and saves the document. From operation 1402 the process proceeds to operation 1404, which edits, saves the document in the financial system. From operation 1404, the process proceeds to operation 1406 which updates the errorlist, returns highest severity error to the integrator. The integrator sends the error information back to the e-procurement system.

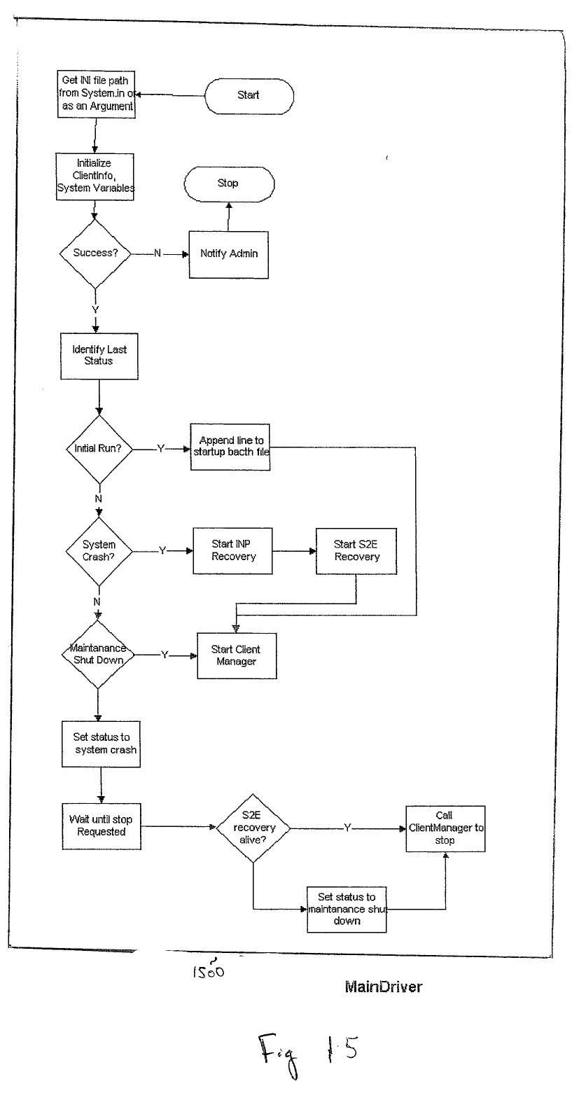

FIG. 15 is a flowchart illustrating one example of a main driver. While this flowchart is written particularly for ADVANTAGE, one of ordinary skill in the art will recognize that a main driver for use with other ERP and financial systems would typically entail a similar process.

Referring now to FIG. 15, block 1500 and the operations incorporated therein serve to implement the start up routine including initializing the system. Block 1500 also implements a recovery after a system crash.

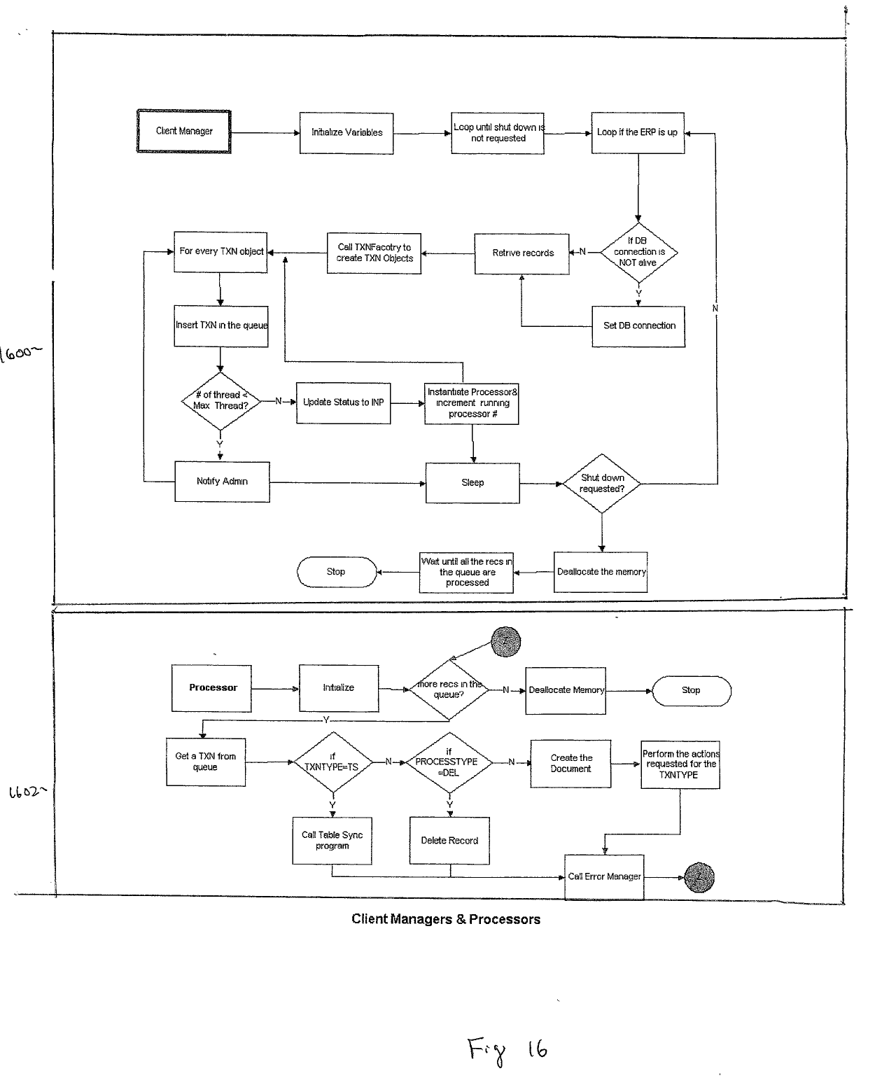

FIG. 16 is a flowchart illustrating one example of a client manager and processor. While this flowchart is written particularly for ADVANTAGE, one of ordinary skill in the art will recognize that a client manager and processor for use with other ERP and financial systems would typically entail a similar process.

Referring now to FIG. 16, block 1600 and the operations incorporated therein serve to implement the client manager. The client manager allows the integrator to integrate with numerous different financial systems or ERP systems. The client manager also manages numerous transactions in the queue and serves as a “resource manager.”

Block 1602 and the operations incorporated therein serve to implement the processor. The processor performs the actual transactions (TXN), and then calls the error manager in case an error occurs.

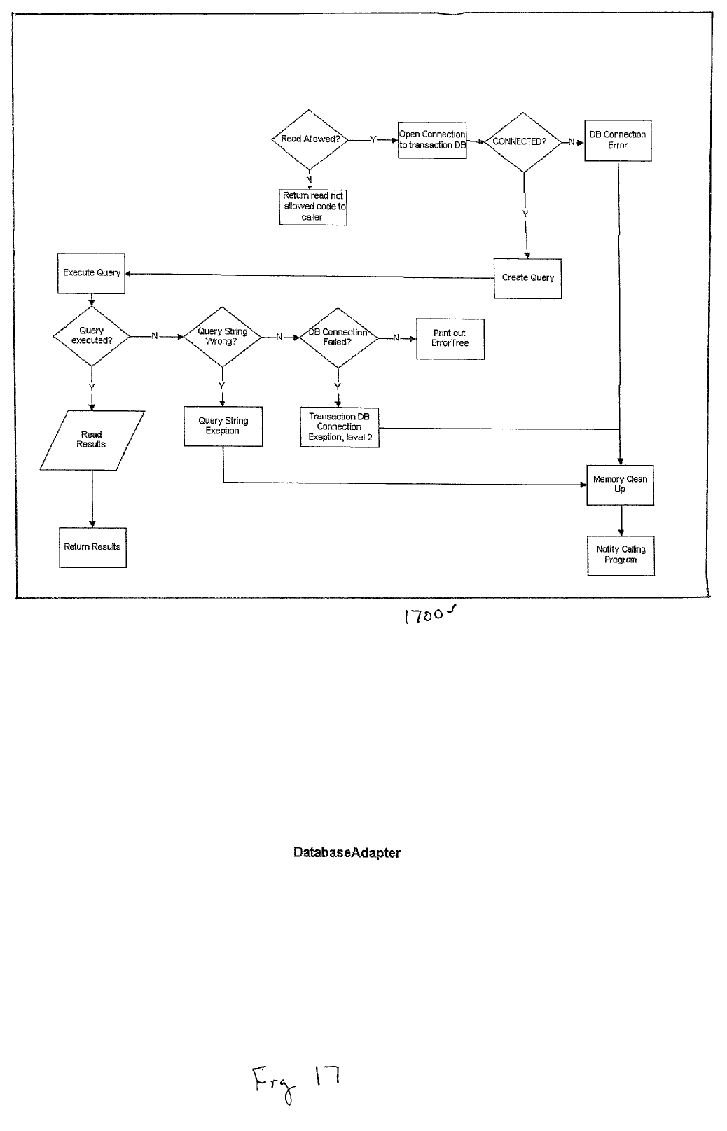

FIG. 17 is a flowchart illustrating one example of a database adapter. While this flowchart is written particularly for ADVANTAGE, one of ordinary skill in the art will recognize that a database adapter for use with other ERP and financial systems would typically entail a similar process.

Referring now to FIG. 17, block 1700 and the operations incorporated therein serve to implement the database adapter. The database adapter manages connections to the transaction database itself. The transaction database can be, for example, a database system available from the ORACLE Company.

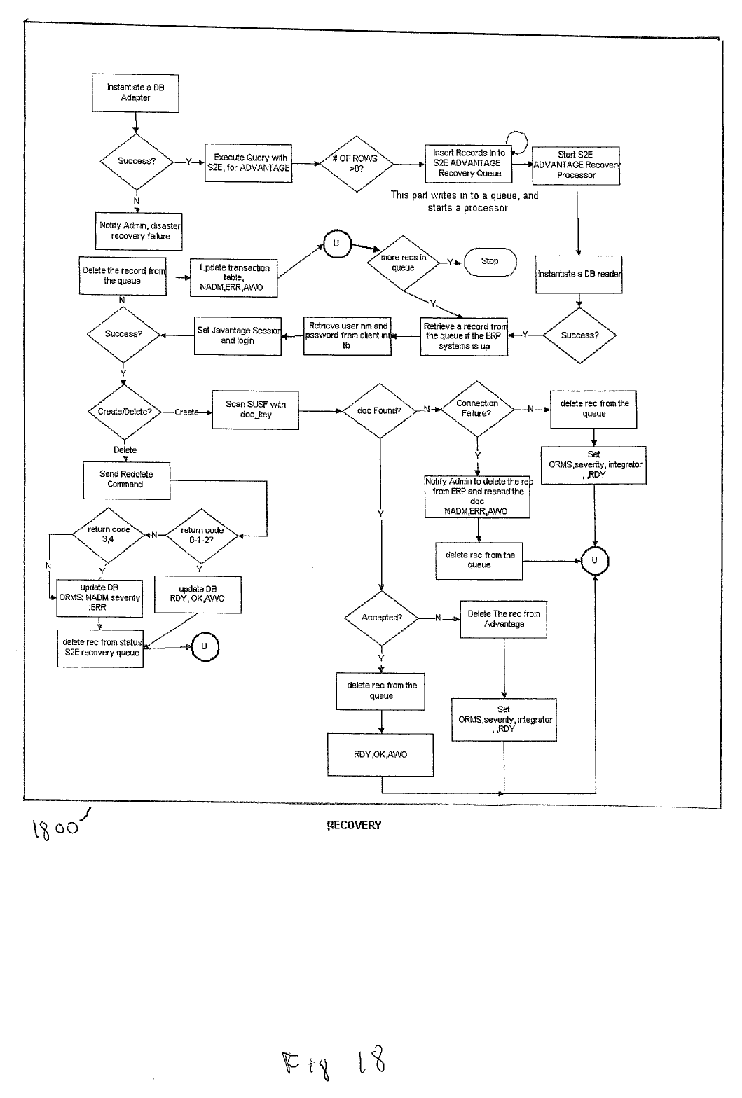

FIG. 18 is a flowchart illustrating one example of a recovery system for use with ADVANTAGE. While this flowchart is written particularly for ADVANTAGE, one of ordinary skill in the art will recognize that such a recovery system for use with other ERP and financial systems would typically entail a similar process.

Referring now to FIG. 18, block 1800 and the operations incorporated therein serve to implement the recovery system. The recovery system is a part of the system that keeps track of integration events in case of a system failure. If a transaction is in progress with an ERP or financial system when the system fails, the recovery system allows the system to pick up where it left off upon restarting.

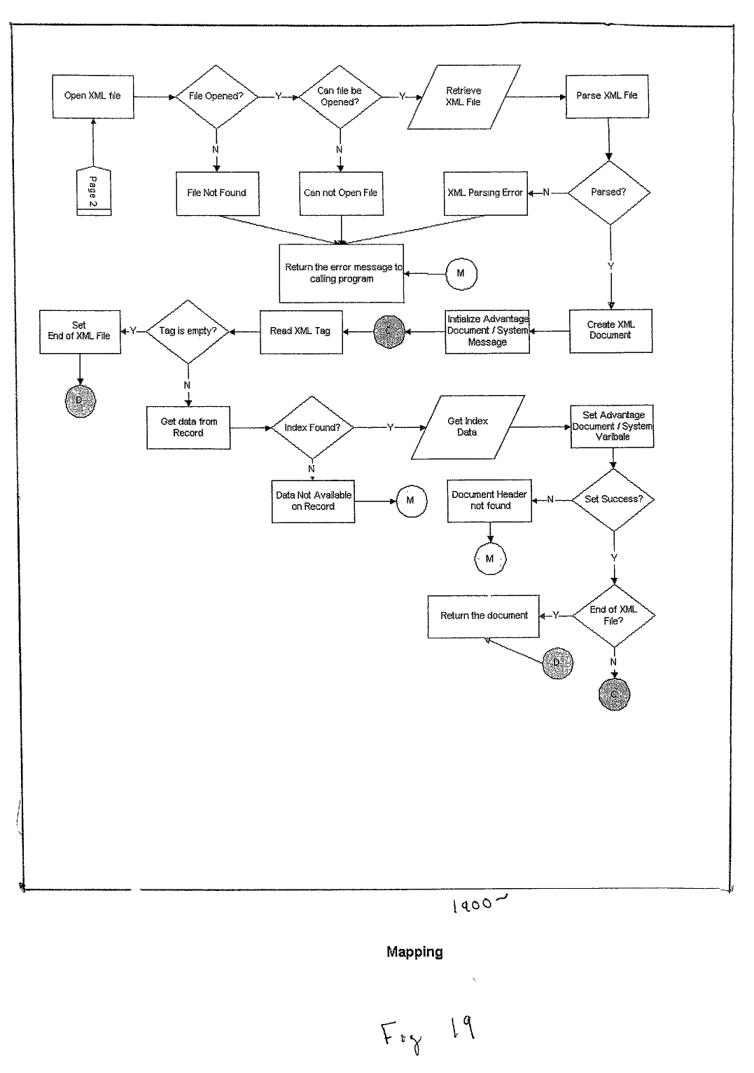

FIG. 19 is a flowchart illustrating one example of the process of mapper. While this flowchart is written particularly for ADVANTAGE, one of ordinary skill in the art will recognize that the mapper process used with other ERP and financial systems would typically entail a similar process.

Referring now to FIG. 19, block 1900 and the operations incorporated therein serve to implement the mapper process. This mapper process is used by the integrator to read the transaction, and with the XML mapper file, decode the transaction data.

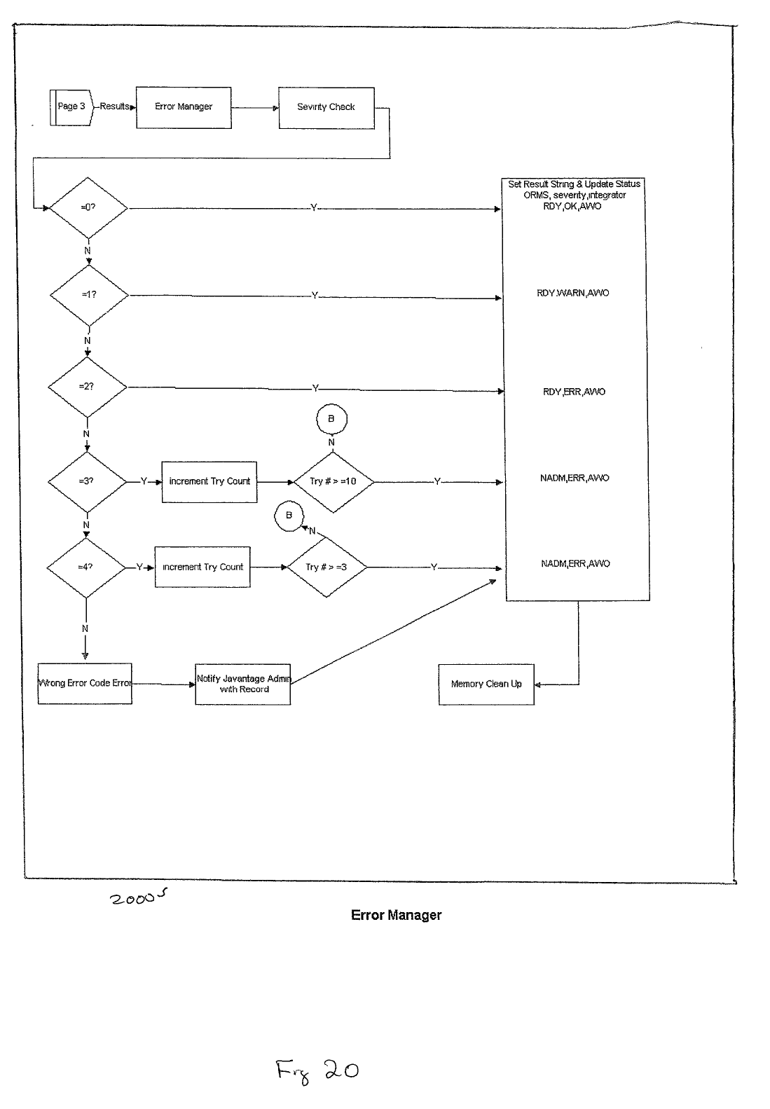

FIG. 20 is a flowchart illustrating one example of the error manager. While this flowchart is written particularly for ADVANTAGE, one of ordinary skill in the art will recognize that an error manager used with other ERP and financial systems would typically entail a similar process.

Referring now to FIG. 20, block 2000 and the operations incorporated therein serve to implement the error manager. The error manager checks to see if an error has not occurred (code 0) or an error has occurred (codes other than 0). Depending on the error code, appropriate flags are set.

All of the above described methods can also be stored on a computer readable storage medium storing a program to instruct a computer to implement the above described methods.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method comprising:
decoding transaction data representing a transaction, from a transaction database, using a parameter based mapper directed to a selected application system selected from a plurality of application systems; and
transferring the decoded transaction data to the selected application system.

2. A method as recited in claim 1, wherein the transaction originates from an electronic procurement system.

3. A method as recited in claim 1, wherein the transaction originates from a hosted electronic procurement system.

4. A method as recited in claim 1, wherein the transaction originates from a shared executable hosted electronic procurement system.

5. A method as recited in claim 1, wherein the transferring transfers the decoded transaction data using a selected application programming interface.

6. A method as recited in claim 1, wherein the mapper is a file generated automatically by a mapper generation program.

7. A method as recited in claim 1, wherein each of the plurality of application systems has a respective mapper.

8. A method as recited in claim 1, wherein the transferring uses an application programming interface to implement the transaction with the selected application system.

9. A method comprising:
encoding a first variable set directed to a first system into transaction data using a parameter based mapper directed to a selected target system of a plurality of target systems;
decoding the transaction data into a second variable set directed to the selected target system, using the mapper; and
transmitting the second variable set to the selected target system.

10. A method recited in claim 9, further comprising storing the transaction data on a transaction database after the encoding, and reading the transaction data from the database before the decoding.

11. A method as recited in claim 9, wherein the transmitting further comprises identifying an application programming interface for the selected target financial system.

12. A method as recited in claim 9, wherein the transmitting further comprises transmitting the second variable set to the identified target system using the identified application programming interface.

13. A method as recited in claim 9, wherein each of the plurality of target systems has a respective mapper.

14. A method as recited in claim 9, wherein the mapper stores a relation between the first variable set and the second variable set.

15. A method as recited in claim 9, wherein the first system is an electronic procurement system.

16. A method as recited in claim 9, wherein the first system is a hosted electronic procurement system.

17. A method as recited in claim 9, wherein the first system is a shared executable hosted electronic procurement system.

18. A method as recited in claim 9, wherein each of the plurality of target systems has a respective application programming interface.

19. A method as recited in claim 9, wherein the mapper is a file generated automatically by a mapper generation program.

20. A method as recited in claim 9, wherein the first variable set and the second variable set both comprise variables and the variables' respective values.

21. A method comprising:
mapping source variables from a source system to intermediate variables in an intermediate system using a table driven mapper file; and
transferring the intermediate variables from the intermediate system to a selected target system of a plurality of target systems using a program adapted for the selected target system.

22. A method comprising:
receiving transaction data representing a transaction from a shared executable hosted electronic procurement system; and
implementing the transaction with a selected application system of a plurality of application systems, using the selected application system's data protocol.

23. A method as recited in claim 22, wherein the implementing is performed using a selected application programming interface.

24. A method as recited in claim 22, wherein the application system is a financial system used to manage financial resources.

25. A method as recited in claim 22, wherein the receiving further comprises decoding the transaction data using a parameter based mapper file.

26. A method comprising:
receiving transaction data representing a transaction from an electronic procurement system; and
implementing the transaction with a selected application system of a plurality of application systems, by using a parameter based mapper file to generate a data file which is transmitted to the selected application system.

27. A computer readable storage medium, storing a computer program to instruct a computer to perform a method comprising:
decoding transaction data representing a transaction, from a transaction database, using a parameter based mapper directed to a selected application system selected from a plurality of application systems; and
transferring the decoded transaction data to the selected application system.

28. A computer readable storage medium as recited in claim 27, wherein the transaction originates from an electronic procurement system.

29. A computer readable storage medium as recited in claim 27, wherein the transaction originates from a hosted electronic procurement system.

30. A computer readable storage medium as recited in claim 27, wherein the transaction originates from a shared executable hosted electronic procurement system.

31. A computer readable storage medium as recited in claim 27, wherein the transferring transfers the decoded transaction data using a selected application programming interface.

32. A computer readable storage medium as recited in claim 27, wherein the mapper is a file generated automatically by a mapper generation program.

33. A computer readable storage medium as recited in claim 27, wherein each of the plurality of application systems has a respective mapper.

34. A computer readable storage medium as recited in claim 27, wherein the transferring uses an application programming interface to implement the transaction with the selected application system.

35. A computer readable storage medium, storing a computer program to instruct a computer to perform a method comprising:
encoding a first variable set directed to a first system into transaction data using a parameter based mapper directed to a selected target system of a plurality of target systems;
decoding the transaction data into a second variable set directed to the selected target system, using the mapper; and
transmitting the second variable set to the selected target system.

36. A computer readable storage medium as recited in claim 35, further comprising storing the transaction data on a transaction database after the encoding, and reading the transaction data from the database before the decoding.

37. A computer readable storage medium as recited in claim 35, wherein the transmitting further comprises identifying an application programming interface for the selected target financial system.

38. A computer readable storage medium as recited in claim 35, wherein the transmitting further comprises transmitting the second variable set to the identified target system using the identified application programming interface.

39. A computer readable storage medium as recited in claim 35, wherein each of the plurality of target systems has a respective mapper.

40. A computer readable storage medium as recited in claim 35, wherein the mapper stores a relation between the first variable set and the second variable set.

41. A computer readable storage medium as recited in claim 35, wherein the first system is an electronic procurement system.

42. A computer readable storage medium as recited in claim 35, wherein the first system is a hosted electronic procurement system.

43. A computer readable storage medium as recited in claim 35, wherein the first system is a shared executable hosted electronic procurement system.

44. A computer readable storage medium as recited in claim 35, wherein each of the plurality of target systems has a respective application programming interface.

45. A computer readable storage medium as recited in claim 35, wherein the mapper is a file generated automatically by a mapper generation program.

46. A computer readable storage medium as recited in claim 35, wherein the first variable set and the second variable set both comprise variables and the variables' respective values.

47. A computer readable storage medium, storing a computer program to instruct a computer to perform a method comprising:
mapping source variables from a source system to intermediate variables in an intermediate system using a table driven mapper file; and
transferring the intermediate variables from the intermediate system to a selected target system of a plurality of target systems using a program adapted for the selected target system.

48. A computer readable storage medium, storing a computer program to instruct a computer to perform a method comprising:
receiving transaction data representing a transaction from a hosted electronic procurement system; and
implementing the transaction with a selected application system of a plurality of application systems, using the selected application system's data protocol.

49. A computer readable storage medium as recited in claim 48, wherein the electronic procurement system is a shared executable hosted system.

50. A computer readable storage medium as recited in claim 48, wherein the application system is a financial system used to manage financial resources.

51. A computer readable storage medium as recited in claim 48, wherein the receiving further comprises decoding the transaction data using a parameter based mapper file.

52. A computer readable storage medium, storing a computer program to instruct a computer to perform a method comprising:
receiving transaction data representing a transaction from an electronic procurement system; and
implementing the transaction with a selected application system of a plurality of application systems, by using a parameter based mapper file to generate a data file which is transmitted to the selected application system.

53. An apparatus comprising:
a plurality of application systems each having a corresponding data protocol;
an electronic procurement system having an electronic procurement system data protocol; and
an integrator mapping the electronic procurement system data protocol to a selected application system's data protocol.

54. An apparatus comprising:
an integrator receiving transaction data representing a transaction; and
an interface processor implementing the transaction with a selected application system of a plurality of application systems by identifying and communicating the transaction using a data protocol corresponding to the selected application system.

55. An apparatus as recited in claim 54, further comprising:
An electronic procurement system storing the transaction data received by the integrator.

56. An apparatus as recited in claim 55, wherein the electronic procurement system is a hosted system.

57. An apparatus as recited in claim 55, wherein the electronic procurement system is a shared executable hosted system.

58. An apparatus as recited in claim 54, wherein the plurality of application systems are financial systems.

59. An apparatus as recited in claim 54, wherein the integrator, after receiving the transaction data, decodes the transaction data using a mapper file.

60. An apparatus as recited in claim 59, wherein the mapper file is parameter based.

61. An apparatus as recited in claim 54, wherein the interface processor further comprises an API storage storing application programming interfaces for corresponding application systems.
